(19) United States
(12) Patent Application Publication
(10) Pub. No.: US 2026/0141874 A1
(43) Pub. Date: May 21, 2026

(54) DISPLAY METHOD FOR PICTURE, TIMING CONTROL REGISTER, AND ELECTRONIC DEVICE

(71) Applicants: Analogix (Suzhou) Semiconductor Co., LTD., Suzhou, Jiangsu (CN); ANALOGIX INTERNATIONAL LLC, City of Wilmington, County of New Castle, DE (US)

(72) Inventors: Fangzheng GUO, Suzhou, Jiangsu (CN); Yuzhi CHEN, City of Wilmington, DE (US); Jinhai WANG, Suzhou, Jiangsu (CN)

(21) Appl. No.: 18/561,742

(22) PCT Filed: Aug. 18, 2023
(86) PCT No.: PCT/CN2023/113871

§ 371 Date: Nov. 17, 2023

(30) Foreign Application Priority Data
Aug. 11, 2023 (CN) 202311014270.3

(51) Int. Cl. G09G 5/00

(52) U.S. Cl. CPC G09G 5/006; G09G 2310/08; G09G 2340/0414; G09G 2340/0421; G09G 2340/12

(57) ABSTRACT

The present disclosure provides a display method for a picture, a timing control register, and an electronic device. The method includes: in a case of receiving a command for displaying a first picture reducing, by a timing control register, an original resolution to a preset resolution, and the first picture is a picture needing to be displayed at the same time as an original picture of a screen; sending the preset resolution to a display card, so that the display card outputs a picture with the preset resolution to obtain a second picture, and sends the second picture to the timing control register; and receiving the first picture and the second picture, and splicing first picture with the second picture into a picture with the original resolution to obtain a target picture, and sending the target picture to the screen for displaying.

### CROSS-REFERENCE TO RELATED APPLICATION

The present disclosure claims the priority of Patent Application No. 202311014270.3 filed on Aug. 11, 2023 and entitled “DISPLAY METHOD FOR PICTURE, TIMING CONTROL REGISTER, AND ELECTRONIC DEVICE”, the content of which is incorporated by reference herein in its entirety.

### TECHNICAL FIELD

The present disclosure relates to the field of screen displaying, and in particular, to a display method for a picture, a timing control register, a non-transitory computer-readable storage medium, and an electronic device.

### BACKGROUND

In a current screen display technology, additional picture display overlays some of original pictures and blocks customers from acquiring valid display information, and moreover, overwritten or blocked pictures cannot be updated in a timely manner. For example, if an information box pops up in a game, update of game pictures will be paused due to displaying of an image of the information box; a television power supply will be watermarked; and the like.

Therefore, there is a need for a method that can solve the problem that new pictures overwrite original pictures, resulting in incomplete information displaying.

### SUMMARY

The present disclosure mainly aims to provide a display method for a picture, a timing control register, a non-transitory computer-readable storage medium, and an electronic device.

According to one aspect of the present disclosure, a display method for a picture is provided, including: an a case of receiving a picture update command, an original resolution is reduced to a preset resolution by a timing control register, and the picture update command is a command for displaying a first picture, and the first picture is a picture needing to be displayed at the same time as an original picture of a screen; the preset resolution is sent to a display card by the timing control register, so that the display card outputs a picture with the preset resolution to obtain a second picture, and sends the second picture to the timing control register; the first picture and the second picture are received by the timing control register; the first picture is spliced with the second picture by the timing control register into a picture with the original resolution to obtain a target picture; and the target picture is sent by the timing control register to the screen for displaying.

In some embodiments, the original resolution is reduced to the preset resolution by the timing control register, which includes any one of the following: a row resolution of the original resolution is reduced by the timing control register to obtain the preset resolution; a column resolution of the original resolution is reduced by the timing control register to obtain the preset resolution; and the row resolution and the column resolution of the original resolution are reduced by the timing control register to obtain the preset resolution.

In some embodiments, the first picture is spliced with the second picture by the timing control register into the picture with the original resolution to obtain the target picture, which includes any one of the following: in a case that the row resolution of the original resolution is reduced by the timing control register, the first picture is spliced with the second picture by the timing control register at top and bottom to obtain the target picture; in a case that the column resolution of the original resolution is reduced by the timing control register, the first picture is spliced with the second picture by the timing control register at left and right to obtain the target picture; and in a case that the row resolution and the column resolution of the original resolution are reduced by the timing control register, the first picture is spliced with the second picture by the timing control register in an embedded manner to obtain the target picture.

In some embodiments, after the target picture is sent by the timing control register to the screen for displaying, the display method further includes: in a case of receiving a command for exiting displaying of the first picture, the original resolution and an interruption signal are sent to the display card by the timing control register, so that the display card outputs a picture with the original resolution to obtain a third picture, and sends the third picture to the timing control register, and the command for exiting displaying the first picture is a command for exiting the first picture; and the third picture is sent by the timing control register to the screen for displaying.

In some embodiments, after the target picture is sent by the timing control register to the screen for displaying, the display method further includes: in a case of receiving a updated first picture, the first picture in the target picture is updated by the timing control register; and in a case of receiving a updated second picture, the second picture in the target picture is updated by the timing control register.

In some embodiments, in the case of receiving the picture update command, before the original solution is reduced to the preset resolution by the timing control register, the method further includes: a fourth picture sent by the display card is received by the timing control register, and the fourth picture is a last frame of a picture that is received by the timing control register before the timing control register reduces the original resolution to the preset resolution and is sent by the display card; and the fourth picture is sent by the timing control register to the screen for displaying. In some embodiments, in a case that the first picture and the second picture are received by the timing control register, the display method further includes: attribute information of the first picture sent by an embedded controller is received by the timing control register, and the attribute information at least includes position information and color information of the first picture.

In some embodiments, the second picture is a picture output by the display card after the display card interrupts, in a case of receiving an interruption signal, a connection link with the timing control register and generates a new connection link according to the preset resolution, and the interruption signal is a signal for controlling the connection link between the timing control register and the display card to be interrupted.

According to another aspect of the present disclosure, a timing control register is provided. The timing control register is configured to: in a case of receiving a picture update command, reduce an original resolution to a preset resolution, wherein the picture update command is a command for displaying a first picture, and the first picture is a picture needing to be displayed at the same time as an original picture of a screen; send the preset resolution to a display card, so that the display card outputs a picture with the preset resolution to obtain a second picture, and sends the second picture to the timing control register; and receive the first picture and the second picture, and splice the first picture with the second picture into a picture with the original resolution to obtain a target picture, and send the target picture to the screen for displaying.

According to still another aspect of the present disclosure, a non-transitory computer-readable storage medium is provided. The non-transitory computer-readable storage medium includes a program stored. The program, when run, controls a device with the non-transitory computer-readable storage medium to perform any one of the display methods.

According to yet another aspect of the present disclosure, an electronic device is provided, including one or more processors, a memory, and one or more programs. The one or more programs are stored in the memory, and are configured to be executed by the one or more processors; and the one or more programs are configured to perform any one of the display methods.

### BRIEF DESCRIPTION OF THE DRAWINGS

The accompanying drawings of this specification forming a part of the preset disclosure are used to provide a further understanding of the present disclosure. The illustrative embodiments and explanations of the present disclosure are used to explain the present disclosure and do not constitute an improper limitation on the present disclosure. In the drawings:

FIG. 1 shows a block diagram of a hardware structure of a mobile terminal that performs a display method for a picture according to an embodiment of the present disclosure;

FIG. 2 shows a flowchart of a display method for a picture according to an embodiment of the present disclosure;

FIG. 3 shows a flowchart of a display method for a picture in the existing technology according to an embodiment of the present disclosure;

FIG. 4 shows a flowchart of a specific display method for a picture according to an embodiment of the present disclosure;

FIG. 5 shows a flowchart of displaying a picture with an original resolution in a specific display method for a picture according to an embodiment of the present disclosure; and

FIG. 6 shows a structural block diagram of a timing control register according to an embodiment of the present disclosure.

The above accompanying drawings include the following reference numerals:
102: processor; 104: memory; 106: transmission device; and 108: input/output device.

### DETAILED DESCRIPTION OF THE EMBODIMENTS

It should be noted that the embodiments in the present disclosure and features in the embodiments may be combined with each other without conflicts. The present disclosure will be described in detail below with reference to the accompanying drawings and in combination with embodiments.

In order to make those skilled in the art better understand the solutions of the present disclosure, the technical solutions in the embodiments of the present disclosure will be described clearly and completely below in combination with the drawings in the embodiments of the present disclosure. Obviously, the embodiments described herein are only part of the embodiments of the present disclosure, not all the embodiments. Based on the embodiments in the present disclosure, all other embodiments obtained by those of ordinary skill in the art without creative work shall fall within the protection scope of the present disclosure.

It should be noted that the terms “first”, “second”, etc. in the specification and claims of the present disclosure and the above drawings are used to distinguish similar objects, and do not have to be used to describe a specific order or sequence. It should be understood that the data used in this way can be interchanged under appropriate circumstances for the purposes of the embodiments of the present disclosure described herein. In addition, the terms “include” and “have” as well as any of their variations are intended to cover non-exclusive inclusions. For example, processes, methods, systems, products, or devices that include a series of steps or components are not necessarily limited to those steps or components clearly listed below, but may include other steps or components that are not clearly listed or are inherent to these processes, methods, products, or devices.

As mentioned in the background, additional picture display will block displaying of information of an original picture. In order to solve the problem that information of an original picture is blocked, embodiments of the present disclosure provide a display method for a picture, a timing control register, a non-transitory computer-readable storage medium, and an electronic device.

The technical solutions in the embodiments of the present disclosure will be described clearly and completely below in combination with the accompanying drawings in the embodiments of the present disclosure.

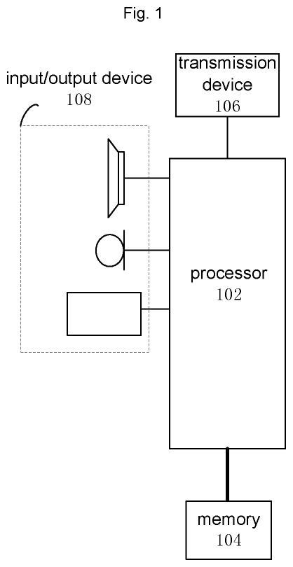

The method embodiment provided in the embodiments of the present disclosure can be implemented in a mobile terminal, a computer terminal, or a similar arithmetic component. Running of the embodiments on a mobile terminal is taken as an example. FIG. 1 is a block diagram of a hardware structure of a mobile terminal that performs a display method for a picture according to an embodiment of the present disclosure. As shown in FIG. 1, the mobile terminal can include one or more (only one is shown in FIG. 1) processors 102 (the processor 102 can include, but is not limited to, a processing device such as a microprocessor MCU or a field programmable logic device (FPGA)) and a memory 104 configured to store data. The mobile terminal can also include a transmission device 106 configured as a communication function and an input/output device 108. Those of ordinary skilled in the art can understand that the structure shown in FIG. 1 is only schematic, and does not limit the structure of the mobile terminal. For example, the mobile terminal may further include more or fewer components than those shown in FIG. 1, or have a different configuration from that shown in FIG. 1.

The memory 104 may be configured to store computer programs, such as software programs and modules of application software, such as computer programs corresponding to the display method for the picture in the embodiments of the present disclosure. The processor 102 executes various functional applications and data processing by running the computer programs stored in the memory 104, that is, to achieve the above method. The memory 104 may include a high-speed Random Access Memory (RAM), and may further include a non-volatile memory, such as one or more magnetic storage apparatuses, a flash memory, or other non-volatile solid-state memories. In some examples, the memory 104 may further include a memory remotely provided with respect to the processor 102, and these remote memories may be connected to the mobile terminal through a network. Examples of the above network include, but are not limited to, the Internet, an intranet, a local area network, a mobile communication network, and combinations thereof. The transmission device 106 is configured to receive or send data via a network. The specific example of the network may include a wireless network provided by a communication provider of the mobile terminal. In one example, the transmission device 106 includes a Network Interface Controller (NIC), which may be connected to other network devices through a base station, so as to communicate with the Internet. In one example, the transmission device 106 may be a Radio Frequency (RF) module, which is configured to communicate with the Internet in a wireless manner.

This embodiment provides a display method for a picture, which is run on a mobile terminal, a computer terminal, or a similar arithmetic device. It should be noted that steps shown in the flow of the drawings may be executed in a computer system with a group of computer-executable instructions, for example. In addition, although a logic order is shown in the flowchart, in some cases, the steps shown or described can be executed in an order different from that herein.

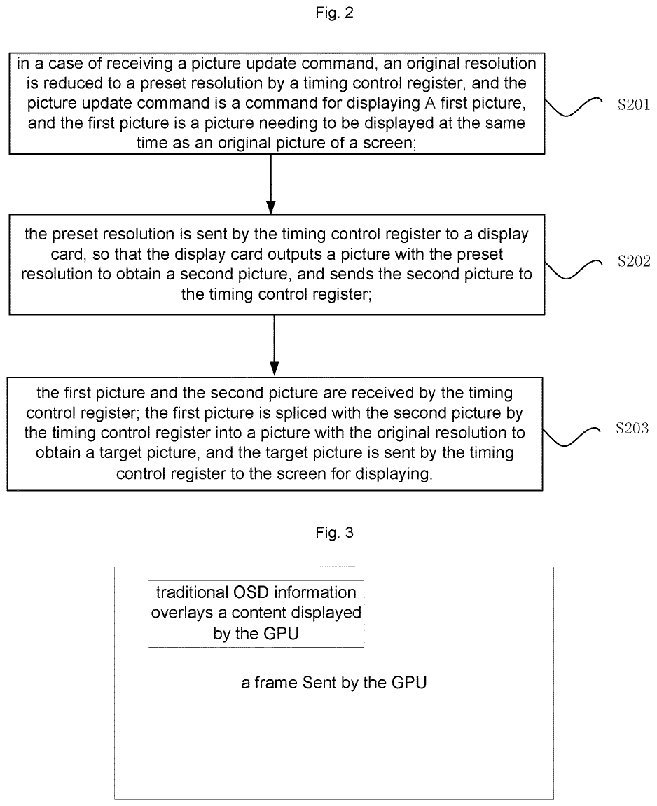

FIG. 2 is a flowchart of a display method for a picture according to an embodiment of the present disclosure. As shown in FIG. 2, the method includes the following steps:

Step S201, in a case of receiving a picture update command, an original resolution is reduced to a preset resolution by a timing control register, and the picture update command is a command for displaying a first picture, and the first picture is a picture needing to be displayed at the same time as an original picture of a screen;

Specifically, if a picture is being displayed on an existing screen, which is referred to as the original picture, the timing control register (TCON) receives the picture update command, that is, the timing control register receives a command for displaying another picture on the basis of the original picture. This picture is referred to as an additional picture in background and referred to as the first picture in the following text. In order to avoid information of the original picture from being blocked by information of the first picture when the first picture is displayed, in the above step, the resolution of the picture is first reduced, that is, the timing control register reduces the original resolution to the preset resolution. This can reduce a space occupied by the original picture on the screen, and further allocate the reduced resolution to the additional picture, namely, the first picture, for displaying, which will no longer cause the problem that the first picture overlays or blocks the original picture.

Step Se202, the preset resolution is sent by the timing control register to a display card, so that the display card outputs a picture with the preset resolution to obtain a second picture, and sends the second picture to the timing control register;

Specifically, the timing control register only reduces the original resolution to the preset resolution, and the display card outputs the picture with the preset resolution. That is, the timing control register sends a parameter, namely, the preset resolution, to the display card, so that the display card outputs the picture with the preset resolution, namely, the second picture, to the timing control register. In other words, the second picture is the original picture with a reduced resolution, and a content displayed on the second picture is the same as that displayed on the original picture, but the resolution has been reduced.

Step S203, the first picture and the second picture are received by the timing control register; the first picture is spliced with the second picture by the timing control register into a picture with the original resolution to obtain a target picture, and the target picture is sent by the timing control register to the screen for displaying.

Specifically, the timing control register receives the second picture sent by the display card, that is, the original picture with the reduced resolution, and receives the additional picture that needs to be displayed at the same time, namely, the first picture. As the resolution of the second picture is less than that of the original picture, a space occupied by the second picture is also reduced. The reduced part is filled by splicing the first picture to obtain a complete picture with the original resolution. The spliced picture with the original resolution includes the first picture (the additional picture in background) and the second picture (the original picture with the reduced resolution), achieving the effect of displaying the two pictures simultaneously without blocking or overlaying each other. Moreover, the first picture and the second picture in the target picture obtained after splicing can be kept being updated, which overcomes the drawback in the existing technology that some contents of the original picture is overlaid or blocked and the original picture cannot be updated again.

According to this embodiment, in the case of receiving the command for displaying the first picture, namely, the picture update command, the timing control register reduces the original resolution of the picture to the preset resolution, and sends the preset resolution to the display card, so that the display card outputs the picture, namely, the second picture, with the preset resolution. The timing control register receives the first picture and the second picture, splices the first picture with the second picture into the picture with the original resolution to obtain a target picture, and sends the target picture to the screen for displaying. Compared with the following method in the existing technology: when two pictures are simultaneously displayed, one picture will overlay information of the other picture, and the overlaid information of the picture cannot be updated, the present disclosure can simultaneously display information of the two pictures, and the information of one picture is not be overlaid and blocked. Furthermore, the two pictures can be kept being updated without affecting each other. Therefore, the following problem in the existing technology can be solved: information of one picture is blocked when two pictures are simultaneously displayed. The purpose of simultaneously displaying information of two pictures is achieved.

In a specific implementation process, the above step S201 can be achieved through the following steps: a row resolution of the original resolution is reduced by the timing control register to obtain the preset resolution; a column resolution of the original resolution is reduced by the timing control register to obtain the preset resolution; and the row resolution and the column resolution of the original resolution are reduced by the timing control register to obtain the preset resolution. The method reduces the parameter, namely, the original resolution, by reducing the row resolution, or the column resolution, or both the row resolution and column resolution. In this way, the original resolution can be reduced in various ways, so as to allocate the reduced resolution to the subsequent first picture that needs to be additionally displayed. The first picture and subsequent second picture are spliced in any of the above ways, which increases the diversity and flexibility of picture displaying.

In some optional embodiments, if the original resolution is 1920×1280, the row resolution is reduced to obtain the preset resolution, for example: 720×1280; the column resolution is reduced to obtain the preset resolution, for example: 1920×1080; and the row resolution and the column resolution are reduced to obtain the preset resolution, for example: 720×1080. Of course, in an actual application process, the preset resolution can be set according to an actual application scenario, that is, the present disclosure does not impose specific restrictions on a value of the above preset resolution.

In order to splice the first picture with the second picture according to the preset resolution to simultaneously display the first picture and the second picture after the splicing, the above step S203 of the present disclosure can be achieved by the following steps: in a case that the row resolution of the original resolution is reduced by the timing control register, the first picture is spliced with the second picture by the timing control register at top and bottom to obtain the target picture; in a case that the column resolution of the original resolution is reduced by the timing control register, the first picture is spliced with the second picture by the timing control register at left and right to obtain the target picture; and in a case that the row resolution and the column resolution of the original resolution are reduced by the timing control register, the first picture is spliced with the second picture by the timing control register in an embedded manner to obtain the target picture. The method splices the received first picture with the received second picture according to the aforementioned method for reducing the resolution, namely, the preset resolution. In this way, the first picture can compensate for the decrease part in the resolution of the second picture according to the preset resolution to obtain the target picture with complete original resolution. Further, while the first picture and the second picture can fill the entire screen, the first picture and the second picture are completely displayed without overlaying or blocking each other, which displays the target picture more flexibly.

Specifically, after reducing the resolution by any one of the above methods to obtain the second picture, if the preset resolution is obtained by the method for reducing the resolution, it can be understood that a quantity of rows of the second picture has been reduced. In this case, the first picture is spliced by compensating for the decrease in the row resolution, which can be specifically as follows: the first picture is placed above the second picture or the first picture is placed below the second picture, namely, the first picture and the second picture are spliced at top and bottom. For example: If the original resolution is 1920×1280, and the preset resolution, namely, the resolution of the second picture, is 720×1280, the resolution of the first picture is 1200×1280. If the preset resolution is obtained by the method for reducing the column resolution, it can be understood that a quantity of columns of the second picture has been reduced. In a case of a decrease in the quantity of columns, the first picture is spliced by compensating for the removed column resolution. Specifically, the first picture is placed on the left of the second picture or the first picture is placed on the right of the second picture, that is, the first picture and the second picture are spliced at left and right. For example, if the original resolution is 1920×1280, and the preset resolution, namely, the resolution of the second picture, is 1920×1080, the resolution of the first picture is 1920×200. If the preset resolution is obtained by reducing the row resolution and the column resolution, it can be understood that a quantity of rows and a quantity of columns of the second picture has been reduced. In this case, the first picture needs to compensate for the decreases in the rows and columns, which can be referred to as embedded splicing. For example, if the original resolution is 1920×1280, and the preset resolution, namely, the resolution of the second picture, is 720×1080, the resolution of the first picture is 1200×200. The first picture can be placed at the left lower corner, right lower corner, left upper corner, right upper corner, or the like of the entire screen. In this way, the second picture is still displayed as a main picture. As the second picture is the original picture with the reduced resolution, displaying the second picture as the main picture can more intuitively cause an audience to obtain information of the main picture, while information of the first picture used as the additional picture is not key information (which is mainly an advertising lamp) that a user needs to obtain. Therefore, the occupied space of the first picture can be relatively small, and the user experience is better.

After the above step S203, the above method further includes the following steps: in a case of receiving a command for exiting displaying the first picture, the original resolution and an interruption signal are sent by the timing control register to the display card, so that the display card outputs a picture with the original resolution to obtain a third picture, and sends the third picture to the timing control register, and the command for exiting displaying the first picture is a command for exiting the first picture; and the third picture is sent by the timing control register to the screen for displaying. In a case of exiting displaying the first picture, the method continues to send the original resolution and cause the display card to output the picture with the original resolution to the screen for displaying. In this way, in a case of exiting displaying the first picture, the first picture will no longer be displayed, and the picture with the original resolution, namely, the third picture, is continued to be displayed.

In a specific implementation process, after the first picture does not need to be displayed, it indicates displaying of the additional picture needs to be exited. The timing control register may receive the command for exiting displaying the first picture, namely, the above command for existing the displaying of the first picture. Afterwards, the beginning original resolution is sent to the display card by the timing control register, so that the display card no longer outputs the second picture according to the preset resolution, but outputs the picture with the original resolution, namely, the third picture. At this point, the third picture is the original picture mentioned earlier, and is also the second picture with the original resolution. The display card sends the third picture to the timing control register. The timing control register further sends the third picture to the screen for displaying, that is, the original displayed picture (original picture) is displayed on the screen. Transmission between the display card and the timing control register is carried out through an Embedded Display Port (EDP, which is a digital port for a laptop computer and a tablet computer) link. In a case that the resolution needs to be changed, the timing control register sends a HPD Interrupt Request (HPD IRQ) and the preset or original resolution to the display card, so that the display card reconfigures the EDP link according to the aforementioned preset resolution or original resolution, and the display card outputs the picture with the preset resolution or original resolution to the timing In order to update the first picture and the second picture in the target picture in a timely manner, in some embodiments, after the above step S203, the above method further includes the following steps: in a case of receiving a updated first picture, the first picture in the target picture is updated by the timing control register; and in a case of receiving a updated second picture, the second picture in the target picture is updated by the timing control register. The method updates the first picture and the second picture after receiving the updated first picture and the updated second picture, so that the target picture can be updated in a timely manner, and both the first picture and the second picture can be updated to avoid the problem that a user cannot obtain updated picture information because one picture cannot be updated during simultaneous displaying of two pictures.

In some optional embodiments, the target picture, namely, the first picture and the second picture, is displayed on the current screen. In a case that each picture is dynamic, the picture itself needs to be updated in real time. According to the above steps, in a case that the updated first picture is received, the first picture is updated in real time; in a case that the updated second picture is received, the second picture is updated in real time; and in a case that the updated first picture and the updated second picture is received at the same time, the first picture and the second picture are both updated, so that a user can obtain information of the first picture and information of the second picture at the same time. As mentioned in the background, in the existing technology, one picture will be blocked or overlaid, and the blocked or overlaid picture cannot be updated in real time. In this way, a user can no longer continue to obtain information of the overlaid picture, but only obtain information of the picture above the overlaid picture, so that the user experience is poor.

In some embodiments, the above step S201 further includes the following steps: in the case of receiving the picture update command, before the original solution is reduced to the preset resolution by the timing control register, a fourth picture sent by the display card is received by the timing control register, and the fourth picture is a last frame of a picture that is received by the timing control register before the timing control register reduces the original resolution to the preset resolution and is sent by the display card; and the fourth picture is sent by the timing control register to the screen for displaying. The method sends the received last frame of the picture with the original resolution, namely, the fourth picture, to the screen for displaying before the first picture and the second picture are displayed. This can avoid such a phenomenon that the screen will stop displaying before a combined picture, namely, the target picture, of the first picture and the second picture is loaded.

Specifically, the timing control register requires a certain buffer time period to reduce the original resolution to the preset resolution and receive the first picture and the second picture. Even if it is a very short time period, the screen cannot stop displaying pictures, for example, a black screen shall not appear, which will cause a poor user experience. Therefore, in a case that the timing control register receives the above picture update command, the timing control register sends the last frame of the picture with the original resolution sent from the display card, that is the original picture, to the screen for displaying, that is, during this buffer time period, the picture with the original resolution is displayed on the screen.

In order to accurately splice the first picture with the second picture, in a specific implementation process, in a case that the timing control register receives the first picture and the second picture, attribute information of the first picture sent by an embedded controller is received by the timing control register, and the attribute information at least includes position information and color information of the first picture. The method simultaneously receives the attribute information of the first picture to better splice the first picture with the second picture according to the attribute information.

In some optional implementations, as the first picture needs to be spliced with the second picture, the first picture needs to have the position information. At the same time, the timing control register also needs to synchronously receive the color information of the first picture, etc, which are collectively referred to as the attribute information. According to the above position information, the timing control register can better splice the first picture with the second picture according to requirements negotiated by the embedded controller (EC).

In a specific implementation process, the second picture is a picture output by the display card after the display card interrupts, in a case of receiving an interruption signal, a connection link with the timing control register and generates a new connection link according to the preset resolution, and the interruption signal is a signal for controlling the connection link between the timing control register and the display card to be interrupted. The timing control register of the method instructs the display card to output the picture with the preset resolution by sending the interruption signal, which can cause the display card to output the picture with the changed resolution, namely, the second picture, to further splice the first picture with the second picture.

Specifically, as mentioned above, the transmission between the display card and the timing control register is carried out through the EDP link. In a case that the resolution needs to be changed, the amount of valid data sent by the link will change, including row valid data and column valid data. The timing control register sends the HPD IRQ and the preset resolution or original resolution to the display card (the preset resolution is sent in the above step), so that the display card reconfigures the EDP link according to the preset resolution, and the display card outputs the picture with the preset resolution, namely, the second picture, to the timing control register.

In order to enable those skilled in the art to have a clearer understanding of the technical solutions of the present disclosure, the following will provide a detailed explanation of an implementation process of the display method for the picture in conjunction with specific embodiments.

This embodiment relates to a specific display method for a picture, as shown in FIG. 3 to FIG. 5, including the following steps:
FIG. 3 shows a display method for a picture in the existing technology. On a frame, namely, a second picture sent by a graphics processing component (GPU), traditional On-screen display (OSD) information (an additional picture, namely, the first picture in the previous text) overlays a content (an original picture, namely, the second picture in the previous text) displayed by the GPU.

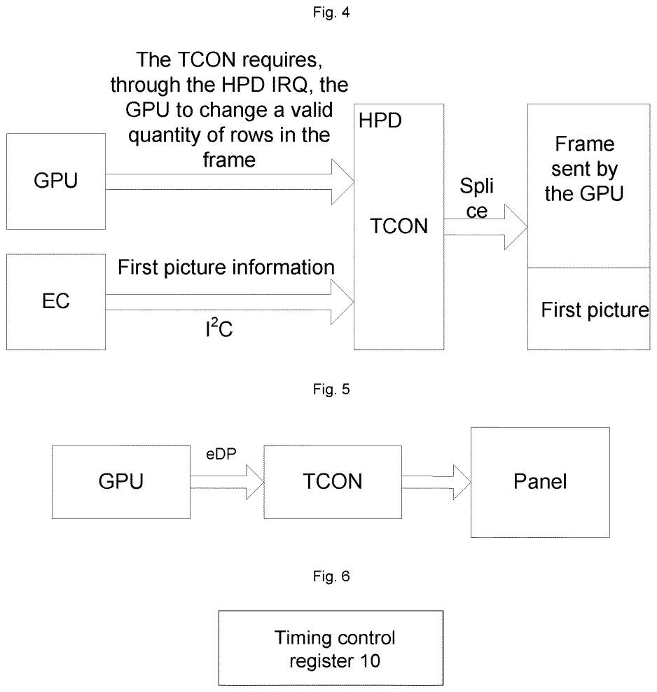

Step S1: FIG. 4 shows the specific display method for the picture disclosed in the present disclosure. When receiving a picture update command (the picture update command is, for example, ANX DPCD), a timing control register (TCON) stores a last frame of picture (a fourth screen) sent by a display card in a static random access memory (SRAM) inside the TCON, and the TCON sends the fourth screen to a screen for displaying.

Step S2: The TCON reduces an original resolution, such as reducing a quantity of rows of extend display identification data (EDID), reducing a quantity of columns in the EDID, or reducing the quantity of rows and the quantity of columns in the EDID, so as to obtain a preset resolution, and sends an HPD IRQ to the display card GPU; the GPU is required to change a valid quantity of rows in the frame; the display card performs eDP link training according to the EDID information and the TCON and changes a resolution of the eDP link, so that the display card sends the picture with the preset resolution, namely, the second picture, to the timing control register through the eDP link.

Step S3: An Embedded Controller (EC) sends a first picture and first picture information (attribute information) to the TCON through an I²C interface. The TCON splices the first picture with the frame sent by the GPU (the second picture sent by the display card) into a picture with the original resolution and sends the picture to the screen for displaying.

Step S4: In a case that the TCON receives the updated first picture and the updated second picture, the TCON can respectively update the second picture sent by the display card or the first picture sent by the embedded controller.

Step S5: FIG. 5 shows a flowchart of receiving a command for exiting displaying the first picture of a system. The TCON restores the original resolution EDID, such as restoring the quantity of rows of the EDID to the quantity of rows of the original EDID, namely, a physical complete valid row of the screen, and sends the HPD IRQ to the display card; the display card GPU outputs the picture with the original resolution, namely, a third picture, through the eDP link according to the EDID information and the TCON, and sends the third picture to a screen panel for displaying.

The embodiments of the present disclosure further provide a timing control register. It should be noted that the timing control register of the embodiments of the present disclosure can be configured to perform the display method for the picture provided in the embodiments of the present disclosure. The apparatus is configured to achieve the above embodiments and preferred implementations. Contents that have been described will not be described in detail. As used below, the term “module” can implement a combination of software and/or hardware with predetermined functions. Although the apparatuses described in the following embodiments are preferably implemented by software, implementation by hardware or a combination of software and hardware is also possible and conceived.

The timing control register provided in the embodiments of the present disclosure will be described below.

FIG. 6 is a schematic diagram of a timing control register according to an embodiment of the present disclosure. As shown in FIG. 6, the timing control register 10 is configured to perform the following actions.

In a case of receiving a picture update command, the timing control register 10 reduces an original resolution to a preset resolution, and the picture update command is a command for displaying a first picture, and the first picture is a picture needing to be displayed at the same time as an original picture of a screen.

Specifically, if a picture is being displayed on an existing screen, which is referred to as the original picture, the timing control register (TCON) receives the picture update command, that is, the timing control register receives a command for displaying another picture on the basis of the original picture. This picture is referred to as an additional picture in background and referred to as the first picture in the following text. In order to avoid information of the original picture from being blocked by information of the first picture when the first picture is displayed, in the above step, the resolution of the picture is first reduced, that is, the timing control register reduces the original resolution to the preset resolution. This can reduce a space occupied by the original picture on the screen, and further allocate the reduced resolution to the additional picture, namely, the first picture, for displaying, which will no longer cause the problem that the first picture overlays or blocks the original picture.

The timing control register 10 sends the preset resolution to a display card, so that the display card outputs a picture with the preset resolution to obtain a second picture, and sends the second picture to the timing control register.

Specifically, the timing control register only reduces the original resolution to the preset resolution, and the display card outputs the picture with the preset resolution. That is, the timing control register sends a parameter, namely, the preset resolution, to the display card, so that the display card outputs the picture with the preset resolution, namely, the second picture, to the timing control register. In other words, the second picture is the original picture with a reduced resolution, and a content displayed on the second picture is the same as that displayed on the original picture, but the resolution has been reduced.

The timing control register 10 receives the first picture and the second picture, splices the first picture with the second picture into a picture with the original resolution to obtain a target picture, and sends the target picture to the screen for displaying.

Specifically, the timing control register receives the second picture sent by the display card, that is, the original picture with the reduced resolution, and receives the additional picture that needs to be displayed at the same time, namely, the first picture. As the resolution of the second picture is less than that of the original picture, a space occupied by the second picture is also reduced. The reduced part is filled by splicing the first picture to obtain a complete picture with the original resolution. The spliced picture with the original resolution includes the first picture (the additional picture in background) and the second picture (the original picture with the reduced resolution), achieving the effect of displaying the two pictures simultaneously without blocking or overlaying each other. Moreover, the first picture and the second picture in the target picture obtained after splicing can be kept being updated, which overcomes the drawback in the existing technology that some contents of the original picture is overlaid or blocked and the original picture cannot be updated again.

According to this embodiment, in the case of receiving the command for displaying the first picture, namely, the picture update command, the timing control register reduces the original resolution of the picture to the preset resolution, and sends the preset resolution to the display card, so that the display card outputs the picture, namely, the second picture, with the preset resolution. The timing control register receives the first picture and the second picture, splices the first picture with the second picture into the picture with the original resolution to obtain a target picture, and sends the target picture to the screen for displaying. Compared with the following apparatus in the existing technology: when two pictures are simultaneously displayed, one picture will overlay information of the other picture, and the overlaid information of the picture cannot be updated, the present disclosure can simultaneously display information of the two pictures, and the information of one picture is not be overlaid and blocked. Furthermore, the two pictures can be kept being updated without affecting each other. Therefore, the following problem in the existing technology can be solved: information of one picture is blocked when two pictures are simultaneously displayed. The purpose of simultaneously displaying information of two pictures is achieved.

In a specific implementation process, the timing control register further includes a first reducing component, a second reducing component, and a third reducing component. The first reducing component is configured to reduce a row resolution of the original resolution to obtain the preset resolution; the second reducing component is configured to reduce a column resolution of the original resolution to obtain the preset resolution; and the third reducing component is configured to reduce the row resolution and the column resolution of the original resolution to obtain the preset resolution. The apparatus reduces the parameter, namely, the original resolution, by reducing the row resolution, or the column resolution, or both the row resolution and column resolution. In this way, the original resolution can be reduced in various ways, so as to allocate the reduced resolution to the subsequent first picture that needs to be additionally displayed. The first picture and subsequent second picture are spliced in any of the above ways, which increases the diversity and flexibility of picture displaying.

In some optional embodiments, if the original resolution is 1920×1280, the row resolution is reduced to obtain the preset resolution, for example: 720×1280; the column resolution is reduced to obtain the preset resolution, for example: 1920×1080; and the row resolution and the column resolution are reduced to obtain the preset resolution, for example: 720×1080. Of course, in an actual application process, the preset resolution can be set according to an actual application scenario, that is, the present disclosure does not impose specific restrictions on a value of the above preset resolution.

In order to splice the first picture with the second picture according to the preset resolution to simultaneously display the first picture and the second picture after the splicing, the timing control register further includes a first splicing component, a second splicing component, and a third splicing component. The first splicing component is configured to: in a case that the row resolution of the original resolution is reduced by the timing control register, splice the first picture with the second picture at top and bottom to obtain the target picture; the second splicing component is configured to: in a case that the column resolution of the original resolution is reduced by the timing control register, splice the first picture with the second picture at left and right to obtain the target picture; and the third splicing component is configured to: in a case that the row resolution and the column resolution of the original resolution are reduced by the timing control register, splice the first picture with the second picture in an embedded manner to obtain the target picture. The apparatus splices the received first picture with the received second picture according to the aforementioned apparatus for reducing the resolution, namely, the preset resolution. In this way, the first picture can compensate for the removed resolution part of the second picture according to the preset resolution to obtain the target picture with complete original resolution. Further, while the first picture and the second picture can fill the entire screen, the first picture and the second picture are completely displayed without overlaying or blocking each other, which displays the target picture more flexibly. Specifically, after reducing the resolution by any one of the above apparatuses to obtain the second picture, if the preset resolution is obtained by the apparatus for reducing the resolution, it can be understood that a quantity of rows of the second picture has been reduced. In this case, the first picture is spliced by compensating for the decrease of the row resolution, which can be specifically as follows: the first picture is placed above the second picture or the first picture is placed below the second picture, namely, the first picture and the second picture are spliced at top and bottom. For example: If the original resolution is 1920×1280, and the preset resolution, namely, the resolution of the second picture, is 720×1280, the resolution of the first picture is 1200×1280. If the preset resolution is obtained by the apparatus for reducing the column resolution, it can be understood that a quantity of columns of the second picture has been reduced. In a case of a decrease in the quantity of columns, the first picture is spliced by compensating for the removed column resolution. Specifically, the first picture is placed on the left of the second picture or the first picture is placed on the right of the second picture, that is, the first picture and the second picture are spliced at left and right. For example, if the original resolution is 1920×1280, and the preset resolution, namely, the resolution of the second picture, is 1920×1080, the resolution of the first picture is 1920×200. If the preset resolution is obtained by reducing the row resolution and the column resolution, it can be understood that a quantity of rows and a quantity of columns of the second picture has been reduced. In this case, the first picture needs to compensate for the decreases in the rows and columns, which can be referred to as embedded splicing. For example, if the original resolution is 1920×1280, and the preset resolution, namely, the resolution of the second picture, is 720×1080, the resolution of the first picture is 1200×200.

The timing control register further includes a first sending component and a second sending component. The first sending component is configured to: in a case of receiving a command for exiting displaying the first picture, send the original resolution and an interruption signal to the display card, so that the display card outputs a picture with the original resolution to obtain a third picture, and sends the third picture to the timing control register, and the command for exiting displaying the first picture is a command for exiting the first picture. The second sending component is configured to send the third picture to the screen for displaying. In a case of exiting displaying the first picture, the apparatus continues to restore the original resolution and cause the display card to output the picture with the original resolution to the screen for displaying. In this way, in a case of exiting displaying the first picture, the first picture will no longer be displayed, and the picture with the original resolution, namely, the third picture, is continued to be displayed.

In a specific implementation process, after the first picture does not need to be displayed, it indicates displaying of the additional picture needs to be exited. The timing control register may receive the command for exiting displaying the first picture, namely, the above command for existing the displaying of the first picture. Afterwards, the beginning original resolution is sent to the display card, so that the display card no longer outputs the second picture according to the preset resolution, but outputs the picture with the original resolution, namely, the third picture. At this point, the third picture is the original picture mentioned earlier, and is also the second picture with the original resolution. The display card sends the third picture to the timing control register. The timing control register further sends the third picture to the screen for displaying, that is, the original displayed picture (original picture) is displayed on the screen. Transmission between the display card and the timing control register is carried out through an Embedded Display Port (EDP, which is a digital port for a laptop computer and a tablet computer) link. In a case that the resolution needs to be changed, the timing control register sends a HPD Interrupt Request (HPD IRQ) and the preset or original resolution to the display card, so that the display card reconfigures the EDP link according to the aforementioned preset resolution or original resolution, and the display card outputs the picture with the preset resolution or original resolution to the timing control register.

In order to update the first picture and the second picture in the target picture in a timely manner, in some embodiments, the timing control register further includes a first update component and a second update component. The first update component is configured to update a first picture in the target picture in a case of receiving the updated first picture. The second update component is configured to update a second picture in the target picture in a case of receiving the updated second picture. The apparatus updates the first picture and the second picture after receiving the updated first picture and the updated second picture, so that the target picture can be updated in a timely manner, and both the first picture and the second picture can be updated to avoid the problem that a user cannot obtain updated picture information because one picture cannot be updated during simultaneous displaying of two pictures.

In some optional embodiments, the target picture, namely, the first picture and the second picture, is displayed on the current screen. In a case that each picture is dynamic, the picture itself needs to be updated in real time. According to the above steps, in a case that the updated first picture is received, the first picture is updated in real time; in a case that the updated second picture is received, the second picture is updated in real time; and in a case that the updated first picture and the updated second picture is received at the same time, the first picture and the second picture are both updated, so that a user can obtain information of the first picture and information of the second picture at the same time. As mentioned in the background, in the existing technology, one picture will be blocked or overlaid, and the blocked or overlaid picture cannot be updated in real time. In this way, a user can no longer continue to obtain information of the overlaid picture, but only obtain information of the picture above the overlaid picture, so that the user experience is poor.

In some embodiments, the timing control register further includes a first receiving component and a third sending component. The first receiving component is configured to: in the case of receiving the picture update command, before the timing control register reduces the original solution to the preset resolution, receive a fourth picture sent by the display card, and the fourth picture is a last frame of a picture that is received by the timing control register before the timing control register reduces the original resolution to the preset resolution and is sent by the display card. The third sending component is configured to send the fourth picture to the screen for displaying. The apparatus sends the received last frame of the picture with the original resolution, namely, the fourth picture, to the screen for displaying before the first picture and the second picture are displayed. This can avoid such a phenomenon that the screen will stop displaying before a combined picture, namely, the target picture, of the first picture and the second picture is loaded.

Specifically, the timing control register requires a certain buffer time period to reduce the original resolution to the preset resolution and receive the first picture and the second picture. Even if it is a very short time period, the screen cannot stop displaying pictures, for example, a black screen shall not appear, which will cause a poor user experience. Therefore, in a case that the timing control register receives the above picture update command, the timing control register sends the last frame of the picture with the original resolution sent from the display card, that is the original picture, to the screen for displaying, that is, during this buffer time period, the picture with the original resolution is displayed on the screen.

In order to accurately splice the first picture with the second picture, in a specific implementation process, the timing control register further includes a second receiving component, configured to: receive attribute information of the first picture sent by an embedded controller, and the attribute information at least includes position information and color information of the first picture. The apparatus simultaneously receives the attribute information of the first picture to better splice the first picture with the second picture according to the attribute information.

In some optional implementations, as the first picture needs to be spliced with the second picture, the first picture needs to have the position information. At the same time, the timing control register also needs to synchronously receive the color information of the first picture, etc, which are collectively referred to as the attribute information. According to the above position information, the timing control register can better splice the first picture with the second picture.

In a specific implementation process, the second picture is a picture output by the display card after the display card interrupts, in a case of receiving an interruption signal, a connection link with the timing control register and generates a new connection link according to the preset resolution, and the interruption signal is a signal for controlling the connection link between the timing control register and the display card to be interrupted. The timing control register of the apparatus instructs the display card to output the picture with the preset resolution by sending the interruption signal, which can cause the display card to output the picture with the changed resolution, namely, the second picture, to further splice the first picture with the second picture.

Specifically, as mentioned above, transmission between the display card and the timing control register is carried out through an EDP link. In a case that the resolution needs to be changed, the timing control register sends an HPD IRQ and the preset resolution or original resolution to the display card (the preset resolution is sent in the above step), so that the display card reconfigures the EDP link according to the preset resolution, and the display card outputs the picture with the preset resolution, namely, the second picture, to the timing control register.

The timing control register includes a processor and a memory. The first receiving component, the second receiving component, and the like are all stored in the memory as program components. The processor executes the above program components stored in the memory to achieve corresponding functions. The above modules are all located in the same processor. Or, the respective modules are respectively located in different processors in the form of any combination. The processor includes a kernel which calls the corresponding program components from the memory. There may be one or more kernels. Information of two pictures are simultaneously displayed by adjusting parameters of the kernel.

The memory may include a volatile memory in a computer-readable medium, a random access memory (RAM) and/or a non-volatile memory, etc., such as a read-only memory (ROM) or a flash RAM. The memory includes at least one storage chip.

Apparently, those skilled in the art should understood that the above-mentioned modules or steps of the present disclosure can all be implemented by a general-purpose computing apparatus, and they can be integrated on a single computing apparatus, or distributed on a network composed of multiple computing apparatuses. They can be implemented using computing-apparatus-executable program codes such that they can be stored in a storage apparatus and executed by computing apparatuses. In some cases, the steps shown or described can be performed in an order different from that herein, or they are separately fabricated into individual integrated circuit modules, or multiple modules or steps in them are fabricated into single integrated circuit modules. In this way, the present disclosure is not limited to any particular hardware and software combinations.

Those skilled in the art should understand that the embodiments of the present disclosure may provide a method, a system or a computer program product. Therefore, the present disclosure may adopt the form of a complete hardware embodiment, a complete software embodiment, or a software and hardware combination embodiment. In addition, the present disclosure may adopt the form of a computer program product implemented on one or multiple computer-available storage media (including, but not limited to, a magnetic disk memory, an optical memory and the like) including computer-available program codes.

The present disclosure is described by referring to flowcharts and/or block diagrams of methods, devices (systems) and computer program products according to the embodiments of the present application. It is worthwhile to note that computer program instructions can be used to implement each flow and/or each block in the flowcharts and/or the block diagrams and a combination of a flow and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specified function in one or more processes in the flowcharts and/or in one or more blocks in the block diagrams.

Alternatively, these computer program instructions can be stored in a computer-readable memory that can instruct the computer or the another programmable data processing device to work in a specific way, so that the instructions stored in the computer-readable memory generate an artifact that includes an instruction apparatus. The instruction apparatus implements a specified function in one or more processes in the flowcharts and/or in one or more blocks in the block diagrams.

These computer program instructions can be loaded onto the computer or the another programmable data processing device, so that a series of operations and steps are performed on the computer or the another programmable device, thereby generating computer-implemented processing. Therefore, the instructions executed on the computer or the another programmable device provide steps for implementing a specified function in one or more processes in the flowcharts and/or in one or more blocks in the block diagrams.

In one typical configuration, a computing device includes one or multiple central processing components (CPU), an input/output interface, a network interface and an internal memory.

The memory may include a volatile memory in a computer-readable medium, a Random Access Memory (RAM) and/or a non-volatile memory, etc., such as a read-only memory (ROM) or a flash RAM. The memory is an example of the computer-readable medium.

The computer-readable medium includes persistent, non-persistent, movable, and unmovable media that can store information by using any method or technology. The information can be computer-readable instructions, data structures, program modules, or other data. Examples of computer storage media include, but not limited to, a Phase-change Random Access Memory (PRAM), a Static Random Access Memory (SRAM), a Dynamic Random Access Memory (DRAM), other types of RAMs, an ROM, an Electrically Erasable Programmable Read-Only Memory (EEPROM), a flash memory or other internal memory technologies, a CD-ROM, a Digital Video Disk (DVD) or other optical memories, a magnetic cartridge type magnetic tape, a magnetic tape/disk storage device or other magnetic storage devices or any other non-transmitting media, and may be used for storing information that may be accessed by the computing device. The computer readable medium does not include transitory computer readable media, such as modulated data signals and carriers, according to definitions herein.

It is worthwhile to note that the terms “include”, “include”, or any other variation thereof are intended to cover a non-exclusive inclusion, so that a process, a method, an article, or a device that includes a list of elements includes those elements and further includes other elements not expressly listed or inherent to such a process, method, article, or device. Elements defined by a sentence “includes a/an . . . ” do not exclude that the process, method, commodity or device that includes the elements still includes other identical elements without more restrictions.

From the above description, it can be seen that the above embodiments of the present disclosure achieve the following technical effects:
1) In the display method for the picture of the present disclosure, in the case of receiving the command for displaying the first picture, namely, the picture update command, the timing control register reduces the original resolution of the picture to the preset resolution, and sends the preset resolution to the display card, so that the display card outputs the picture, namely, the second picture, with the preset resolution. The timing control register receives the first picture and the second picture, splices the first picture with the second picture into the picture with the original resolution to obtain a target picture, and sends the target picture to the screen for displaying. Compared with the following method in the existing technology: when two pictures are simultaneously displayed, one picture will overlay information of the other picture, and the overlaid information of the picture cannot be updated, the present disclosure can simultaneously display information of the two pictures, and the information of one picture is not be overlaid and blocked. Furthermore, the two pictures can be kept being updated without affecting each other. Therefore, the following problem in the existing technology can be solved: information of one picture is blocked when two pictures are simultaneously displayed. The purpose of simultaneously displaying information of two pictures is achieved.
2) According to the present disclosure, in the case of receiving the command for displaying the first picture, namely, the picture update command, the timing control register reduces the original resolution of the picture to the preset resolution, and sends the preset resolution to the display card, so that the display card outputs the picture, namely, the second picture, with the preset resolution. The timing control register receives the first picture and the second picture, splices the first picture with the second picture into the picture with the original resolution to obtain a target picture, and sends the target picture to the screen for displaying. Compared with the following apparatus in the existing technology: when two pictures are simultaneously displayed, one picture will overlay information of the other picture, and the overlaid information of the picture cannot be updated, the present disclosure can simultaneously display information of the two pictures, and the information of one picture is not be overlaid and blocked. Furthermore, the two pictures can be kept being updated without affecting each other. Therefore, the following problem in the existing technology can be solved: information of one picture is blocked when two pictures are simultaneously displayed. The purpose of simultaneously displaying information of two pictures is achieved.

The above descriptions are only preferred embodiments of the present disclosure, and are not intended to limit the present disclosure. Those skilled in the art can make various modifications and changes to the present disclosure. Any modification, equivalent replacement, improvement, and the like made within the spirit and principle of the present disclosure shall be included in the protection scope of the present disclosure.

1. A display method for a picture, comprising:
in a case of receiving a picture update command, reducing, by a timing control register, an original resolution to a preset resolution, wherein the picture update command is a command for displaying a first picture, and the first picture is a picture needing to be displayed at the same time as an original picture of a screen;
sending, by the timing control register, the preset resolution to a display card, so that the display card outputs a picture with the preset resolution to obtain a second picture, and sends the second picture to the timing control register; and
receiving, by the timing control register, the first picture and the second picture, and splicing, by the timing control register, the first picture with the second picture into a picture with the original resolution to obtain a target picture, and sending, by the timing control register, the target picture to the screen for displaying.

2. The display method according to claim 1, wherein reducing, by the timing control register, the original resolution to the preset resolution comprises any one of the following:
reducing, by the timing control register, a row resolution of the original resolution to obtain the preset resolution;
reducing, by the timing control register, a column resolution of the original resolution to obtain the preset resolution; and
reducing, by the timing control register, the row resolution and the column resolution of the original resolution to obtain the preset resolution.

3. The display method according to claim 2, wherein splicing, by the timing control register, the first picture with the second picture into the picture with the original resolution to obtain the target picture comprises any one of the following:
in a case that the timing control register reduces the row resolution of the original resolution, splicing, by the timing control register, the first picture with the second picture at top and bottom to obtain the target picture;
in a case that the timing control register reduces the column resolution of the original resolution, splicing, by the timing control register, the first picture with the second picture at left and right to obtain the target picture; and
in a case that the timing control register reduces the row resolution and the column resolution of the original resolution, splicing, by the timing control register, the first picture with the second picture in an embedded manner to obtain the target picture.

4. The display method according to claim 1, wherein after sending, by the timing control register, the target picture to the screen for displaying, the display method further comprises:
in a case of receiving a command for exiting displaying the first picture, sending, by the timing control register the original resolution and an interruption signal to the display card, so that the display card outputs a picture with the original resolution to obtain a third picture, and sends the third picture to the timing control register, wherein the command for exiting displaying the first picture is a command for exiting the first picture; and
sending, by the timing control register, the third picture to the screen for displaying.

5. The display method according to claim 1, wherein after sending, by the timing control register, the target picture to the screen for displaying, the display method further comprises:
in a case of receiving a updated first picture, updating, by the timing control register, the first picture in the target picture; and
in a case of receiving a updated second picture, updating, by the timing control register, the second picture in the target picture.

6. The display method according to claim 1, wherein in the case of receiving the picture update command, before reducing, by the timing control register, the original resolution to the preset resolution, the method further comprises:
receiving, by the timing control register, a fourth picture sent by the display card, wherein the fourth picture is a last frame of a picture that is received by the timing control register before the timing control register reduces the original resolution to the preset resolution and is sent by the display card; and
sending, by the timing control register, the fourth picture to the screen for displaying.

7. The display method according to claim 1, wherein in a case that the timing control register receives the first picture and the second picture, the display method further comprises:
receiving, by the timing control register, attribute information of the first picture sent by an embedded controller, wherein the attribute information at least comprises position information and color information of the first picture.

8. The display method according to claim 1, wherein the second picture is a picture output by the display card after the display card interrupts, in a case of receiving an interruption signal, a connection link with the timing control register and generates a new connection link according to the preset resolution, wherein the interruption signal is a signal for controlling the connection link between the timing control register and the display card to be interrupted.

9. (canceled)

10. A non-transitory computer-readable storage medium, wherein the non-transitory computer-readable storage medium comprises a program stored; the program, when run, controls a device with the non-transitory computer-readable storage medium to perform:
in a case of receiving a picture update command, reducing, by a timing control register, an original resolution to a preset resolution, wherein the picture update command is a command for displaying a first picture, and the first picture is a picture needing to be displayed at the same time as an original picture of a screen;
sending, by the timing control register, the preset resolution to a display card, so that the display card outputs a picture with the preset resolution to obtain a second picture, and sends the second picture to the timing control register; and
receiving, by the timing control register, the first picture and the second picture, and splicing, by the timing control register, the first picture with the second picture into a picture with the original resolution to obtain a target picture, and sending, by the timing control register, the target picture to the screen for displaying.

11. An electronic device, comprising: one or more processors, a memory, and one or more programs, wherein the one or more programs are stored in the memory, and are configured to be executed by the one or more processors; and the one or more programs are configured to:
in a case of receiving a picture update command, reduce, by a timing control register, and original resolution to a preset resolution, wherein the picture update command is a command for displaying a first picture, and the first picture is a picture needing to be displayed at the same time as an original picture of a screen;
send, by the timing control register, the preset resolution to a display card, so that the display card outputs a picture with the preset resolution to obtain a second picture, and sends the second picture to the timing control register, and
receive, by the timing control register, the first picture and the second picture, and splice, by the timing control register, the first picture with a second picture into a picture with the original resolution to obtain a target picture, and send, by the timing control register, the target picture to the screen for displaying.

12. The electronic device according to claim 11, wherein the one or more programs are further configured to:
reduce, by the timing control register, a row resolution of the original resolution to obtain the preset resolution;
reduce, by the timing control register, a column resolution of the original resolution to obtain the preset resolution; and
reduce, by the timing control register, the row resolution and the column resolution of the original resolution to obtain the preset resolution.

13. The electronic device according to claim 12, wherein the one or more programs are further configured to:
in a case that the timing control register reduces the row resolution of the original resolution, splice, by the timing control register, the first picture with the second picture at top and bottom to obtain the target picture;
in a case that the timing control register reduces the column resolution of the original resolution, splice, by the timing control register, the first picture with the second picture at left and right to obtain the target picture; and
in a case that the timing control register reduces the row resolution and the column resolution of the original resolution, splice, by the timing control register, the first picture with the second picture in an embedded manner to obtain the target picture.

14. The electronic device according to claim 11, wherein the one or more programs are further configured to:
after sending, by the timing control register, the target picture to the screen for displaying, in a case of receiving a command for exiting displaying the first picture, send, by the timing control register the original resolution and an interruption signal to the display card, so that the display card outputs a picture with the original resolution to obtain a third picture, and sends the third picture to the timing control register, wherein the command for exiting displaying the first picture is a command for exiting the first picture; and
send, by the timing control register, the third picture to the screen for displaying.

15. The electronic device according to claim 11, wherein the one or more programs are further configured to:
after sending, by the timing control register, the target picture to the screen for displaying, in a case of receiving a updated first picture, update, by the timing control register, the first picture in the target picture; and
in a case of receiving a updated second picture, update, by the timing control register, the second picture in the target picture.

16. The electronic device according to claim 11, wherein the one or more programs are further configured to:
in the case of receiving the picture update command, before reducing, by the timing control register, the original resolution to the preset resolution, receive, by the timing control register, a fourth picture sent by the display card, wherein the fourth picture is a last frame of a picture that is received by the timing control register before the timing control register reduces the original resolution to the preset resolution and is sent by the display card; and
send, by the timing control register, the fourth picture to the screen for displaying.

17. The electronic device according to claim 11, wherein the one or more programs are further configured to:
in a case that the timing control register receives the first picture and the second picture, receive, by the timing control register, attribute information of the first picture sent by an embedded controller, wherein the attribute information at least comprises position information and color information of the first picture.

18. The electronic device according to claim 11, wherein the second picture is a picture output by the display card after the display card interrupts, in a case of receiving an interruption signal, a connection link with the timing control register and generates a new connection link according to the preset resolution, wherein the interruption signal is a signal for controlling the connection link between the timing control register and the display card to be interrupted.

19. The non-transitory computer-readable storage medium according to claim 10, wherein the program, when run, controls the device with the non-transitory computer-readable storage medium to perform:
reducing, by the timing control register, a row resolution of the original resolution to obtain the preset resolution;
reducing, by the timing control register, a column resolution of the original resolution to obtain the preset resolution; and
reducing, by the timing control register, the row resolution and the column resolution of the original resolution to obtain the preset resolution.

20. The non-transitory computer-readable storage medium according to claim 19, wherein the program, when run, controls the device with the non-transitory computer-readable storage medium to perform:
in a case that the timing control register reduces the row resolution of the original resolution, splicing, by the timing control register, the first picture with the second picture at top and bottom to obtain the target picture;
in a case that the timing control register reduces the column resolution of the original resolution, splicing, by the timing control register, the first picture with the second picture at left and right to obtain the target picture; and
in a case that the timing control register reduces the row resolution and the column resolution of the original resolution, splicing, by the timing control register, the first picture with the second picture in an embedded manner to obtain the target picture.

21. The non-transitory computer-readable storage medium according to claim 10, wherein the program, when run, controls the device with the non-transitory computer-readable storage medium to perform:
in a case of receiving a command for exiting displaying the first picture, sending, by the timing control register the original resolution and an interruption signal to the display card, so that the display card outputs a picture with the original resolution to obtain a third picture, and sends the third picture to the timing control register, wherein the command for exiting displaying the first picture is a command for exiting the first picture; and
sending, by the timing control register, the third picture to the screen for displaying.
